(19) United States
(12) Patent Application Publication
(10) Pub. No.: US 2005/0125962 A1
(43) Pub. Date: Jun. 16, 2005

(54) Locking structure for combing a hook and a hanging ring

(76) Inventor: Steven Hong, Taichung (TW)

Correspondence Address: STEVEN HONG, 235 CHUNG-HO BOX 8-24, TAIPEI HSIEN, 235, TW

(21) Appl. No.: 10/736,098

(22) Filed: Dec. 16, 2003

(51) Int. Cl. F16B 45/02

(52) U.S. Cl. 24/265 H

(57) ABSTRACT

A locking structure for combing a hook and a hanging ring comprises a hook member, a hanging ring, a screw nut and a spring lock pin. The screw nut having a plurality of radially distributed blocks formed on an upper end thereof. And the spaces between adjacent blocks define a plurality of radially distributed retaining slots. The locking section of the hook member is inserted through the base of the hanging ring and connects the screw nut. The spring lock pin is inserted through the through hole and two opposite retaining slots so as to lock the hook member and the hanging ring together. Thereby, the self-gravity of the hook member can pull the screw nut downward so that the spring lock pin is pressed against the screw nut and thus secured, without the riveting mechanism necessary in conventional locking structures.

### FIELD OF INVENTION

The present invention relates to locking structures for combing a hook and a hanging ring, more particularly to a locking structure for combing a hook and a hanging ring in which a lock pin is retained within a screw nut mounted on the hook and is secured by the self gravity of the hook.

### DESCRIPTION OF THE PRIOR ART

Referring to FIG. 4, a locking structure for combing a hook and a hanging ring of the prior art comprises a hook member 1 and a hanging ring 2; the hanging ring 2 is mounted on the top end of the hook member 1. A locking section 11A with helical screw groove extends from the top of the hook member 1. A fixing tab 112 is formed at the top end of the locking section 11A. The hanging ring includes a ring coupler 21 that can be coupled with the locking section 11A and gets secured thereon by a screw nut 3A mounted above the ring coupler 21. A riveting machine presses the fixing tab 112 on a blocking plate 311 so as to lock the hanging ring 2 onto the hook member 3.

The conventional locking structure for combing a hook and a hanging ring is disadvantageous in that the space encircled by the hanging ring 2 and the associated ring coupler 21 is so limited so that the riveting job therebetween is difficult.

### SUMMARY OF THE INVENTION

Accordingly, a locking structure for combing a hook and a hanging ring according to the present invention comprises a hook member and a hanging ring. The hook member has a cylindrical locking section extending from the top end of the hook member. The locking section includes a through hole running radially through a cross-section of the locking section. The hanging ring includes a ring coupler capable of being mounted onto the locking section. The present invention further includes a screw nut having a plurality of radially distributed blocks formed on an upper end thereof. And the spaces between adjacent blocks define a plurality of radially distributed retaining slots. The present invention is further provided with a spring lock pin capable of being inserted into the through hole of the locking section.

The locking section of the hook member is inserted through the ring coupler of the hanging ring and connects the screw nut. The screw nut is twisted and moved along the locking section to align two opposite retaining slots with the through hole of the locking section. The spring lock pin is inserted through the through hole and those two opposite retaining slots so as to lock the hook member and the hanging ring together. Thereby, the self-gravity of the hook member can pull the screw nut downward with respect to the ring coupler of the hanging ring so that the spring lock pin is pressed against an upper horizontal face of the screw nut and thus secured, without a riveting mechanism necessary in the conventional locking structure.

### DESCRIPTION OF THE DRAWINGS

FIG. 1 is an exploded perspective view of the present invention.

FIG. 2 is a perspective view of the present invention in an assembled state.

FIG. 3 is a lateral cross-sectional view of the present invention.

FIG. 4 is a lateral cross-sectional view of a conventional locking structure for combing a hook and a hanging ring.

### DETAILED DESCRIPTION OF THE PREFERRED EMBODIMENTS

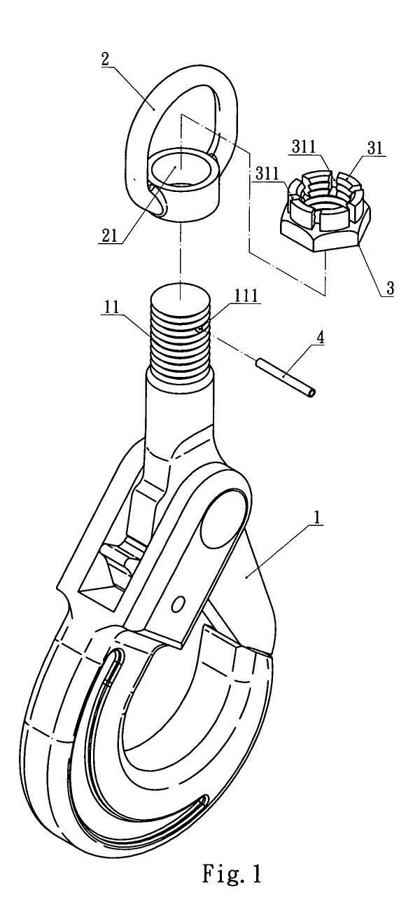

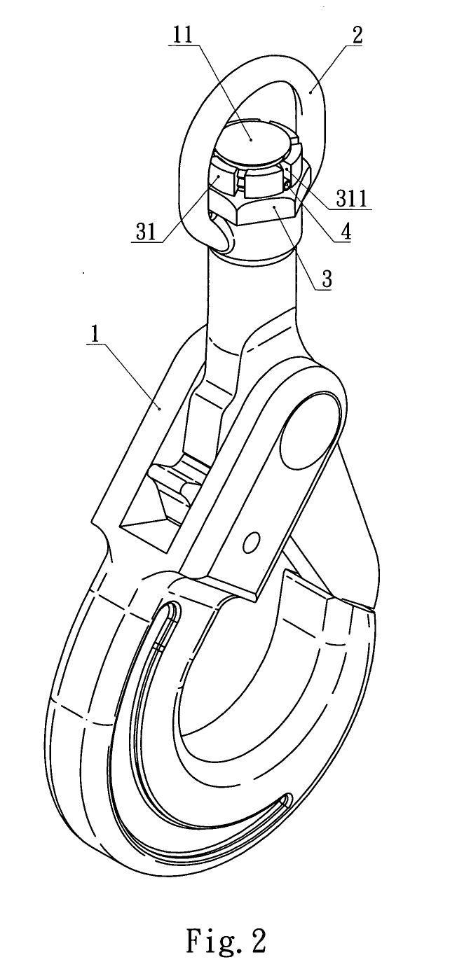

Referring to FIGS. 1 and 2, a locking structure for combing a hook and a hanging ring according to the present invention comprises a hook member 1 and a hanging ring 2 attached with the hook member 1. A hook member 1 includes a cylindrical section extending in the upward direction. The upper portion of the section, being provided with a helical screw groove, defines a locking section 11. The locking section 11 further includes a through hole 111 that goes transversely across the locking section 11.

The hanging ring 2 further includes a ring coupler 21 for being put around the locking section 11 of the hook member 1 in a way that the locking section 11 extends through the ring coupler 21 of the hanging ring 2. After the hanging ring 2 is mounted onto the locking section 11 of the hook member 1, a screw nut 3 is applied to the top portion of the locking section 11. The screw nut 3 has a plurality of radially distributed blocks 31, forming a circle designed to be smaller than the inner circular wall of the screw nut 3. The redially distributed spaces between the blocks 31 define a plurality of retaining slots 311. The screw nut 3 can be twisted around the locking section 11 so that the through hole 111 in the locking section 11 is aligned with two opposite retaining slots 311.

A spring lock pin 4 with a length equal to the diameter of the circle defined by the blocks 31 is inserted through a retaining slot 311 into the through hole 111 in the locking section 11 and out of an opposite retaining slot 311, so that the spring lock pin 4 is supported on a flat face of the screw nut 3. Thereby, the hook member 1 and the hanging ring 2 are locked together.

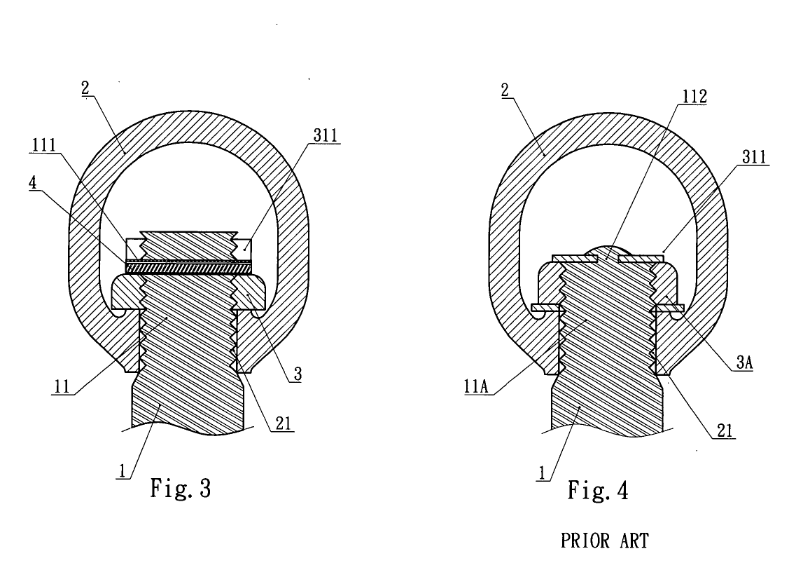

As shown in FIG. 3, the spring lock pin 4, passing through the through hole 111 in the locking section 11 for mounting the screw nut 3 and the retaining slots 311 of the screw nut 3, provides a mechanism lock the hanging ring 2 on the top of the hook member 1. Since the length of the spring lock pin 4 is equal to the diameter of the circularly arranged blocks 31, the spring lock pin 4 is not likely to collide with a foreign object and thereby falls off the screw nut 3.

The hook member 1 and the hanging ring 2 are locked by a spring lock pin 4, which is supported against a horizontal face on the screw nut 3 by the gravitational pull of the hook member 1. In this configuration, the lower ring coupler 21 of the hanging ring 2 and the upper screw nut 3 are pressed against each other, enhancing the connection of the spring lock pin 4 with the screw nut 3. This locking structure eliminates the process of riveting in combing a hook member and a hanging ring, making the assembly of a hanging hook more convenient.

1. A locking structure for combing a hook and a hanging ring comprising: a hook member having a cylindrical locking section extending from a top thereof, the locking section including a through hole which runs redially through a cross-section of the locking section;
a hanging ring including a ring coupler capable of being mounted onto the locking section;
a screw nut having a plurality of radially distributed blocks formed on an upper end thereof, spaces between adjacent blocks defining a plurality of radially distributed retaining slots; and
a spring lock pin capable of being inserted into the through hole of the locking section;
the locking section of the hook member being inserted through the ring coupler of the hanging ring and connecting the screw nut, the screw nut being twisted and moved along the locking section to align two opposite retaining slots thereon with the through hole of the locking section, the spring lock pin being inserted through the through hole and those two opposite retaining slots so as to lock the hook member and the hanging ring together;
whereby self-gravity of the hook member will cause the screw nut to move downward with respect to the ring coupler of the hanging ring so that the spring lock pin resists against an upper horizontal face of the screw nut and thus secured, without a riveting mechanism in conventional locking structures for combing a hook and a hanging ring process.

2. The locking structure for combing a hook and a hanging ring of claim 1, wherein the spring lock pin has a length equal to a diameter of the radially distributed blocks so that the spring lock pin is not likely to collide with a foreign object and falls off the screw nut.
